(19) United States
(12) Patent Application Publication
(10) Pub. No.: US 2014/0094177 A1
(43) Pub. Date: Apr. 3, 2014

(54) WIRELESS COMMUNICATION APPARATUS AND WIRELESS COMMUNICATION METHOD

(71) Applicant: Fujitsu Mobile Communications Limited, Kawasaki-shi (JP)

(72) Inventor: Masaru SHUTO, Kokubunji (JP)

(73) Assignee: Fujitsu Mobile Communications Limited, Kawasaki-shi (JP)

(21) Appl. No.: 14/034,250

(22) Filed: Sep. 23, 2013

(30) Foreign Application Priority Data
Oct. 1, 2012 (JP) 2012-219357

(51) Int. Cl. H04W 36/30

(52) U.S. Cl. CPC H04W 36/30
USPC 455/437

(57) ABSTRACT

A wireless communication apparatus including: a storage unit that stores timer values for a search of each of a plurality of wireless access networks, wherein each of the timer values is set according to communication characteristics of an application and a use priority of a wireless access network, and each of the timer values is associated with the application and the wireless access network; a timer unit that activates, when communication by an application is started, a timer at a timer value associated with the application and a wireless access network selected as a standby; and a selection unit that newly selects, when a wireless access network with a higher use priority than the wireless access network selected as the standby is detected by a search on expiration of the timer during the communication, the wireless access network with the higher use priority as a standby network.

### CROSS-REFERENCE TO RELATED APPLICATION

This application is based upon and claims the benefit of priority of the prior Japanese Patent Application No. 2012-219357, filed on Oct. 1, 2012, the entire contents of which are incorporated herein by reference.

### FIELD

The present invention relates to a wireless communication apparatus and a wireless communication method that select one wireless access network to be used for communication from a plurality of wireless access networks.

### BACKGROUND

Examples of a wireless access network include a third generation mobile communication system (3rd Generation hereinafter, simply “3G”), Wi-Fi (Wireless Fidelity), and WiMAX (Worldwide Interoperability for Microwave Access). Some wireless communication apparatuses can use a plurality of wireless access networks. The wireless communication apparatus that can use the wireless access networks searches wireless access networks at predetermined intervals and selects one of the detected wireless access networks according to a predetermined standard to perform communication.

### PATENT DOCUMENT

[Patent document 1] Japanese Patent Laid-Open No. 2008-42913

However, the wireless communication apparatus searches the wireless access networks at predetermined intervals regardless of an application or a wireless access network selected as a standby. Therefore, the wireless communication apparatus has the following problems.

For example, if a search is performed just before the start of communication by an application in which a high throughput is demanded, the next search is executed after a time substantially equivalent to a predetermined interval from the start of the communication. For example, if the search interval is a relatively long time such as 60 seconds, the time from the start of the communication to the execution of the next search is long. While a wireless access network at a slow communication speed is used, the communication may end without a switch to a faster wireless access network. Furthermore, for example, in communication by an application with a small amount of communication that is sufficiently completed in a slow wireless access network, the timing of the search based on a predetermined interval is just after the start of the communication, and the electric power may be excessively consumed by the search.

### SUMMARY

An aspect of the present invention provides a wireless communication apparatus that can be connected to a plurality of wireless access networks, the wireless communication apparatus including:

a storage unit that stores timer values for a search of each of the plurality of wireless access networks, wherein each of the timer values is set according to communication characteristics of an application and according to a use priority of a wireless access network, and each of the timer values is associated with the application and the wireless access network;

a timer unit that activates, when communication by an application is started, a timer at a timer value that is stored in the storage unit and that is associated with the application and associated with a wireless access network selected as a standby,; and

a selection unit that newly selects, when a wireless access network with a higher use priority than the wireless access network selected as the standby is detected by a search of the wireless access network on expiration of the timer during the communication, the wireless access network with the higher use priority as a standby network.

Another aspect of the present invention provides a wireless communication method executed by the wireless communication apparatus. Other aspects of the present invention can include a wireless communication program causing a computer to function as the wireless communication apparatus and a computer-readable recording medium recording the program. The recording medium readable by a computer and the like denotes a recording medium that accumulates information of data, programs, and the like by electrical, magnetic, optical, mechanical, or chemical effects and that can be read by a computer and the like.

The object and advantage of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a hardware configuration of a wireless communication apparatus;

FIG. 2 is a diagram illustrating an example of functional blocks of the wireless communication apparatus;

FIG. 3 is a diagram illustrating an example of a timer value setting table;

FIG. 4A is an example of a flow chart of a process by a system selection unit;

FIG. 4B is an example of a flow chart of a process by the system selection unit;

FIG. 5A is an example of a flow chart of a process by a 3G processing unit, a WiMAX processing unit, and a Wi-Fi processing unit of the wireless communication apparatus;

FIG. 5B is an example of a flow chart of a process by the 3G processing unit, the WiMAX processing unit, and the Wi-Fi processing unit of the wireless communication apparatus;

FIG. 6A is a diagram illustrating an example of a sequence of a process between the functional blocks of the wireless communication apparatus;

FIG. 6B is a diagram illustrating an example of a sequence of a process between the functional blocks of the wireless communication apparatus;

FIG. 7A is a diagram illustrating a specific example 1 of state transitions of the wireless communication apparatus;

FIG. 7B is a diagram illustrating the specific example 1 of the state transitions of the wireless communication apparatus;

FIG. 8A is a diagram illustrating a specific example 2 of state transitions of the wireless communication apparatus; and

FIG. 8B is a diagram illustrating the specific example 2 of the state transitions of the wireless communication apparatus.

### DESCRIPTION OF EMBODIMENTS

Hereinafter, an embodiment of the present invention will be described with reference to the drawings. A configuration of the following embodiment is illustrative, and the present invention is not limited to the configuration of the embodiment.

### First Embodiment

In a first embodiment, a wireless communication apparatus includes a timer value for search that is set according to communication characteristics of an application and according to a use priority of a wireless access network and that is associated with a combination of the application and the wireless access network. The timer value is a timer value indicating an execution interval of a search of a wireless access network during communication by an application. The search of a wireless access network is a process of determining whether the wireless access network is available at a position of the wireless communication apparatus. For example, the search of the wireless access network is performed by determining whether reception intensity of a radio wave used by the wireless access network is equal to or greater than a predetermined threshold. Hereinafter, the search of the wireless access network will also be simply called “search”. A search of another wireless network when a standby wireless network is selected will be called a re-search of a wireless network or simply a re-search.

In communication by an application, the wireless communication apparatus activates a timer at a timer value according to the application and according to the wireless access network selected as a standby. When the communication by the application is continuing upon the expiration of the timer, the wireless communication apparatus searches each wireless access network other than the wireless access network selected for the standby. Use priorities are allocated to the wireless access networks. If a wireless access network with a higher use priority than the wireless access network selected as the standby is detected, the wireless communication apparatus newly selects the wireless access network with the higher use priority as a standby wireless access network. The wireless communication apparatus reactivates the timer at a timer value according to the application and according to the wireless access network with the higher use priority newly selected as the standby. If the communication by the application is continuing when the timer expires and a wireless access network with a higher use priority than the wireless access network selected as the standby is not detected, the wireless communication apparatus sets the timer value by extending the last timer value by a predetermined length and reactivates the timer. This reduces the number of executions of the search during the communication by the application and reduces the power consumption. Hereinafter, the use priority will be simply called a priority.

The wireless communication apparatus also holds, for each application, setting of enable/disable of execution of the search of the wireless access network at the start of communication. If the execution of the search of the wireless access network at the start of communication by the application is set to “enable”, the search of the wireless access network is executed at the start of communication, in addition to when the timer expires. If the execution of the search of the wireless access network at the start of communication by the application is set to “disable”, the search of the wireless access network is not executed at the start of communication, and the search of the wireless access network is executed when the timer expires. Hereinafter, the wireless access network will be simply called a wireless network.

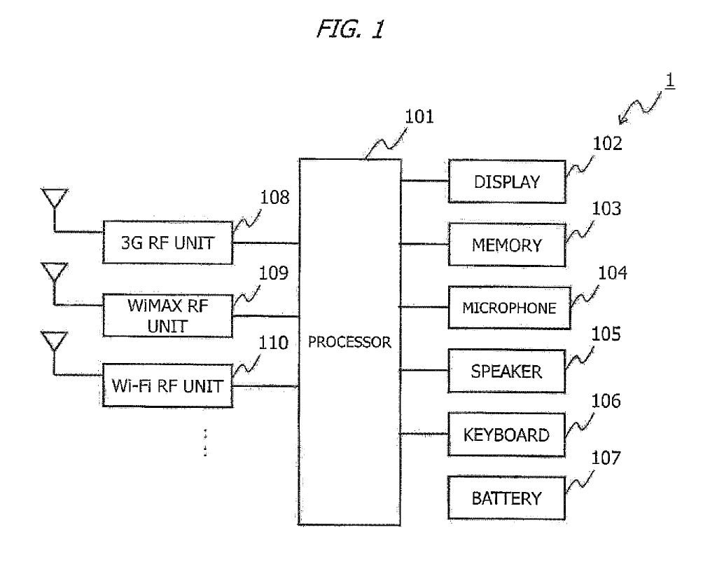

FIG. 1 is a diagram illustrating an example of a hardware configuration of a wireless communication apparatus. The wireless communication apparatus is, for example, a smartphone, a music player with wireless communication function, a mobile tablet terminal with wireless communication function, and a PC with wireless communication function.

The wireless communication apparatus 1 includes a processor 101, a display 102, a memory 103, a microphone 104, a speaker 105, a keyboard 106, a battery 107, a 3G RF (Radio Frequency) unit 108, a WiMAX RF unit 109, and a Wi-Fi RF unit 110.

The processor 101 is, for example, a CPU (Central Processing Unit). The processor may be a microprocessor. The memory 103 includes a ROM (Read Only Memory) and a RAM (Random Access Memory). The RAM includes both a volatile RAM and a non-volatile RAM. The non-volatile RAM stores various applications and wireless communication programs. Examples of the applications stored in the RAM include a mailer, a browser, and a tethering. The wireless communication programs are programs for executing processes related to selection of a standby wireless network, communication using the wireless network, and the like.

The display 102 is an output apparatus. The display 102 is, for example, a liquid crystal display (Liquid Crystal Display, LCD). The display 102 displays screen data according to a signal input from the processor 101.

A touch panel may be arranged on the surface of the display 102. The touch panel is a position input apparatus, and coordinates of a touch position of a finger corresponding to the screen of the display 102 are input. The touch panel may adopt any system, such as a resistive-film system, a surface acoustic system, an infrared system, an electromagnetic induction system, and an electrostatic capacity system.

The microphone 104 is a voice input apparatus. The microphone 104 collects voices. The microphone 104 is connected to a circuit that converts an input voice signal to an electrical signal. The circuit converts the voice signal input from the microphone 104 to an electrical signal and outputs the electrical signal to the processor 101.

The speaker 105 is a voice output apparatus. The speaker 105 is connected to a circuit that converts an electrical signal input from the processor 101 to a voice signal, and the speaker 105 outputs the voice signal input from the circuit.

The keyboard 106 is an input apparatus. The keyboard 106 includes a plurality of input buttons. Each input button outputs a corresponding press signal to the processor 101 when the user presses the input button.

The battery 107 is, for example, a rechargeable power supply apparatus. The battery 107 can be attached to and detached from the wireless communication apparatus 1.

Each of the 3G RF unit 108, the WiMAX RF unit 109, and the Wi-Fi RF unit 110 is connected to an antenna, and wireless signals from 3G, Wi-MAX, and Wi-Fi networks are input and output through the antennas. Each of the 3G RF unit 108, the WiMAX RF unit 109, and the Wi-Fi RF unit 110 includes a circuit that converts an input wireless signal to an electrical signal to output the electrical signal to the processor 101 and that converts an electrical signal input from the processor 101 to a wireless signal to transmit the wireless signal through the antenna.

Each of the 3G RF unit 108, the WiMAX RF unit 109, and a Wi-Fi RF unit 110 includes a processor. The processor searches each corresponding wireless network upon generation of a predetermined event, for example. Examples of the predetermined event include search instruction from the processor 101 and expiration of the timer.

The hardware configuration of the wireless communication apparatus 1 is not limited to the one illustrated in FIG. 1, and changes, such as additions, replacements, and deletions, can be made for the constituent elements as necessary. For example, the wireless communication apparatus 1 may include a unit of LTE (Long Term Evolution) or the like as a constituent element related to wireless communication. For example, the wireless communication apparatus 1 may include a removable IC card, an infrared communication unit for infrared communication, and a Bluetooth communication unit for communication using a Bluetooth (registered trademark). The wireless communication apparatus 1 may also include a portable recording medium driving apparatus that drives a portable recording medium, such as a USB memory and an SD card.

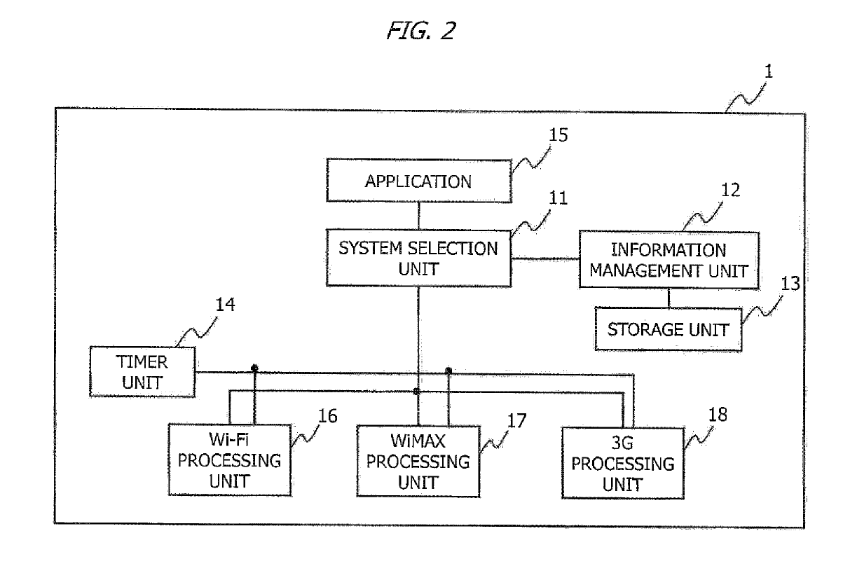

FIG. 2 is a diagram illustrating an example of functional blocks of the wireless communication apparatus 1. The wireless communication apparatus 1 includes, as functional blocks, a system selection unit 11, an information management unit 12, a storage unit 13, a timer unit 14, an application 15, a Wi-Fi processing unit 16, a WiMAX processing unit 17, and a 3G processing unit 18.

The processor 101 executes the wireless communication programs stored in the memory 103 to execute processes by the system selection unit 11, the information management unit 12, and the timer unit 14. The processor 101 also executes various application stored in the memory 103 to execute processes by the application 15. The storage unit 13 is created in the memory 103, for example. The Wi-Fi processing unit 16, the WiMAX processing unit 17, and the 3G processing unit 18 correspond to the Wi-Fi RF unit 110, the WiMAX RF unit 109, and the 3G RF unit 108, respectively.

The application 15 is activated by user input and starts communication by user input, for example. The application 15 notifies the system selection unit 11 of the start and the end of communication.

The Wi-Fi processing unit 16, the WiMAX processing unit 17, and the 3G processing unit 18 execute processes related to communication using Wi-Fi, WiMAX, and 3G, respectively. Hereinafter, a wireless network as a target of a process by each of the Wi-Fi processing unit 16, the WiMAX processing unit 17, and the 3G processing unit 18 will be called an assigned wireless network. Specifically, examples of the processes related to communication include search of the assigned wireless network, a standby process of the assigned wireless network, and establishment, maintenance, or disconnection of a session in the assigned wireless network. The standby of a wireless network denotes a state in which a paging channel is viewed at a predetermined period. The paging channel denotes a channel used to call out a terminal. In the first embodiment, the wireless communication apparatus 1 waits for one of Wi-Fi, WiMAX, and 3G in data communication. In the first embodiment, the waited wireless network will be called a standby network. In the first embodiment, the Wi-Fi processing unit 16, the WiMAX processing unit 17, and the 3G processing unit 18 will be collectively called wireless processing units.

When a notification indicating that the assigned wireless network is selected as the standby network is received from the system selection unit 11, each wireless processing unit executes a standby process or a process related to communication during the communication. The standby process and the process related to communication are known processes, and the processes will not be described in the present specification.

Each wireless processing unit in charge of a wireless network other than the standby network (hereinafter, each wireless processing unit other than the standby) instructs the timer unit 14 to activate the timer at a timer value notified from the system selection unit 11. When the timer expires, each wireless processing unit other than the standby re-searches the assigned wireless network. If communication is not generated by any application, the timer value notified by the system selection unit 11 is a default value. If communication is not generated by any application, each wireless processing unit other than the standby instructs reactivation of the timer, while the timer value remains at the default value.

If communication is generated by any application, the timer value transmitted by the system selection unit 11 to each wireless processing unit other than the standby is a timer value according to the application and according to the wireless network as the standby network. If communication is generated by any application and if the assigned network is not selected as the standby network as a result of the search upon the expiration of the timer, each wireless processing unit other than the standby instructs reactivation of the timer at a timer value twice as long as the last time. However, the upper limit of the timer value is 120 seconds. Note, the timer value at the reactivation is not limited to the value twice as much as the last timer value. For example, the timer value may be a value derived by multiplying the last timer value by a predetermined number or may be a value derived by adding a predetermined time length to the last timer value. The upper limit value of the timer value is not limited to 120 seconds.

The system selection unit 11 instructs the Wi-Fi processing unit 16, the WiMAX processing unit 17, and the 3G processing unit 18 to search each assigned wireless network. The system selection unit 11 selects one wireless network as a standby network, based on the search result of each assigned wireless network input from each of the Wi-Fi processing unit 16, the WiMAX processing unit 17, and the 3G processing unit 18. In the first embodiment, the priority is set in the order of Wi-Fi >WiMAX >3G, and the system selection unit 11 selects, as the standby network, the wireless network with the highest priority among the detected wireless networks. The priority of the wireless network is set based on the load, the usage fee, and the like. For example, 3G is a network of a telecommunications carrier, and the load and the fee are high. Meanwhile, Wi-Fi does not pass through a network of a telecommunications carrier, and the fee is low. Therefore, the priority is set high. However, the priority order of the wireless networks is not limited to this. The system selection unit 11 instructs the search of the wireless network when the wireless communication apparatus 1 is activated or when an instruction for starting communication is received from an application, for example.

The system selection unit 11 notifies the wireless processing unit in charge of the standby network of the fact that the network is selected as the standby network. The wireless processing unit that has received the notification executes a process related to standby or communication. The process related to standby or communication is a known process, and the process will not be described in the present specification.

When an instruction for starting communication is input from the application 15, the system selection unit 11 acquires, from the information management unit 12, information regarding the application stored in a timer value setting table. The timer value setting table is stored in the storage unit 13, and enable/disable of re-search at the start of communication by the application and a timer value for search according to the application and the standby network are stored. Details of the timer value setting table will be described later.

More specifically, the system selection unit 11 acquires, from the information management unit 12, enable/disable of the re-search at the start of communication by the application and a timer value for search according to the application and the standby network. If the re-search of the wireless network at the start of communication by the application is set to “enable”, the system selection unit 11 instructs the wireless processing units other than the standby to perform the re-search. If a wireless network with a higher priority than the standby network is detected, the system selection unit 11 newly selects the wireless network with the higher priority as the standby network. The system selection unit 11 acquires, from the timer value setting table and through the information management unit 12, a timer value according to the application that performs the communication and according to the wireless network newly selected as the standby network. The system selection unit 11 notifies the wireless processing units other than the standby of the acquired timer values. Each wireless processing unit instructs the timer unit 14 to activate the timer at the notified timer value.

If the re-search of the wireless network at the start of communication by the application is set to “disable”, the system selection unit 11 notifies the wireless processing units other than the standby of the timer values acquired from the timer value setting table. Each wireless processing unit instructs the timer unit 14 to activate the timer at the notified timer value. The system selection unit 11 is an example of a “selection unit”.

The timer unit 14 includes timers for each of the Wi-Fi processing unit 16, the WiMAX processing unit 17, and the 3G processing unit 18 and activates each timer based on an instruction from each unit. The timer value of each wireless processing unit is notified from each wireless processing unit along with the instruction for the timer activation. When each timer expires, the timer unit 14 notifies each wireless processing unit of the timer expiration. The timer unit 14 is an example of a “timer unit”.

The information management unit 12 manages the timer value setting table stored in the storage unit 13. For example, the information management unit 12 reads information stored in the timer value setting table according to a request from the system selection unit 11.

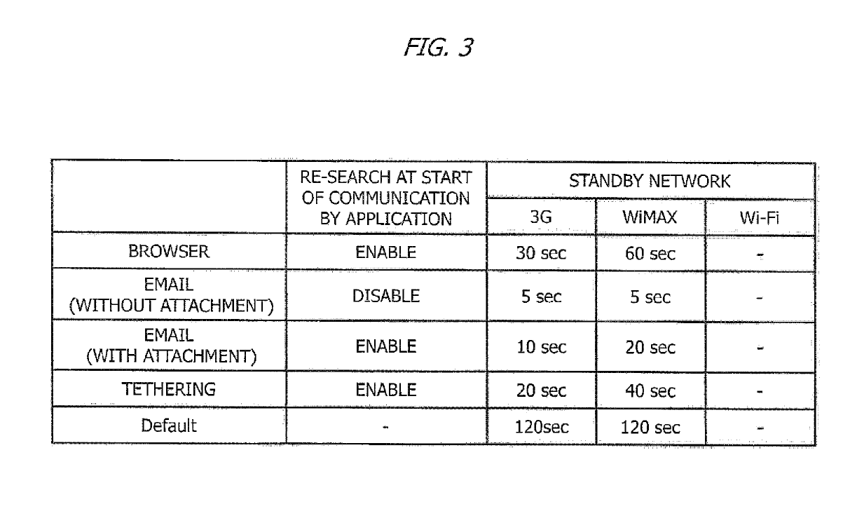

FIG. 3 is a diagram illustrating an example of the timer value setting table. The timer value setting table illustrated in FIG. 3 is a timer value setting table when the priority of the wireless network is Wi-Fi >WiMAX >3G. The timer value setting table is stored in advance in the storage unit 13.

Entries of the timer value setting table are prepared for each application for communication mounted on the wireless communication apparatus 1. The entries include enable/disable of re-search at the start of communication by the application and a timer value for search when each wireless network is selected as the standby network. In the example illustrated in FIG. 3, entries of browser, email (without attached file), email (with attached file), and tethering are illustrated as applications for communication. Timer values when communication is not performed by any application, that is, default values, are also set in the entries of the timer value setting table (written as “Default” in FIG. 3).

The enable/disable of the re-search at the start of communication by the application is set to “enable” for an application with a large amount of communication or for an application with a long communication continuation time, for example. Among the applications in the example illustrated in FIG. 3, the browser and the tethering are the applications with long communication continuation times. This is for performing communication using a faster wireless network in an application with a long communication continuation time. Among the applications in the example illustrated in FIG. 3, the tethering and the email with attached file are the applications with large amounts of communication. Therefore, the re-search at the start of communication by the application is set to “enable” for the browser, the tethering, and the email with attached file in the example illustrated in FIG. 3. However, the re-search at the activation of the application is set to “disable” for the email if there is no attached file, because the amount of communication is small.

The timer value for search is set according to characteristics and tendency of the communication by each application and according to the use priority of the wireless network. Examples of the characteristics of the communication by the application include an amount of transmitted and received data, communication continuation time, and whether the communication is sporadic. For example, the timer value for search is set shorter for an application with a shorter communication continuation time, that is, an application with sporadic or intermittent communication. The timer value for search is set longer for an application with a longer communication continuation time. This is for reducing the power consumption of the wireless communication apparatus 1 caused by the re-search of the network in the communication by the application with a long communication continuation time. In the application with sporadic communication, if a maximum value of an amount of data is defined for example, the timer value may be set according to the maximum amount of data. In the application with sporadic communication, if the communication by the application is not finished before the set timer value, the radio wave environment may be degraded. Therefore, the timer value for search is set short to speed up the change of the standby network.

The timer value for search is set shorter for an application with a large amount of communication and is set longer for an application with a small amount of communication, for example. This is for more quickly changing the standby network to a wireless network at a high communication speed in the application with a large amount of communication.

The timer value for search is set shorter when the priority set to the wireless network is lower, that is, when the communication speed of the wireless network is slower. This is for more quickly changing the standby network to a wireless network at a faster communication speed, from a wireless network with a low priority, that is, with a slow communication speed. In the entries of the browser in the example illustrated in FIG. 3, the timer value when the standby network is 3G is set to 30 seconds, and the timer value when the standby network is WiMAX is set to 60 seconds. However, the priority of Wi-Fi is the highest in the first embodiment, and when Wi-Fi is the standby network, the standby network is not changed even if another wireless network is detected. Therefore, if Wi-Fi is the standby network, the re-search of another wireless network is not performed. As a result, if Wi-Fi is the standby network, the timer value for re-search is not set in the example illustrated in FIG. 3.

In the example illustrated in FIG. 3, the communication by the browser has characteristics and a tendency that the amount of communication is relatively small and sporadic access continues for a long time. Therefore, longer timer values of 30 seconds (3G) and 60 seconds (WiMAX) are set. The communication by the email without attached file has characteristics and a tendency that the amount of communication is relatively small, the communication is sporadic, and the communication continuation time is short. Therefore, a shorter timer value of 5 seconds is set for 3G and WiMAX. If the maximum amount of data is defined, a value enough to transmit the defined amount of data is set for the timer value of the email without attached file. The communication by the email with attached file is different from the communication by the email without attached file in that the amount of data is large. Therefore, the timer values of the email with attached file are set to 10 seconds (3G) and 20 seconds (WiMAX) that are longer than the timer value of the email without attached file.

Although the communication continuation time of the communication by the tethering is long, the amount of communication is relatively large. Therefore, the timer values are set to 20 seconds (3G) and 40 seconds (WiMAX) that are shorter than in the browser. The execution intervals of the search are reduced by setting the timer values short, and communication using a faster wireless network can be easily provided.

For example, although not illustrated in FIG. 3, if there is an application in which a predetermined wireless network is determined as the wireless network used for communication, the other wireless networks are not used. Therefore, in an entry of an application in which a predetermined wireless network is determined as the wireless network used for communication, the timer value of which a wireless network other than the predetermined wireless network selected as the standby network is not set, so that the re-search is not performed.

### Operation Example

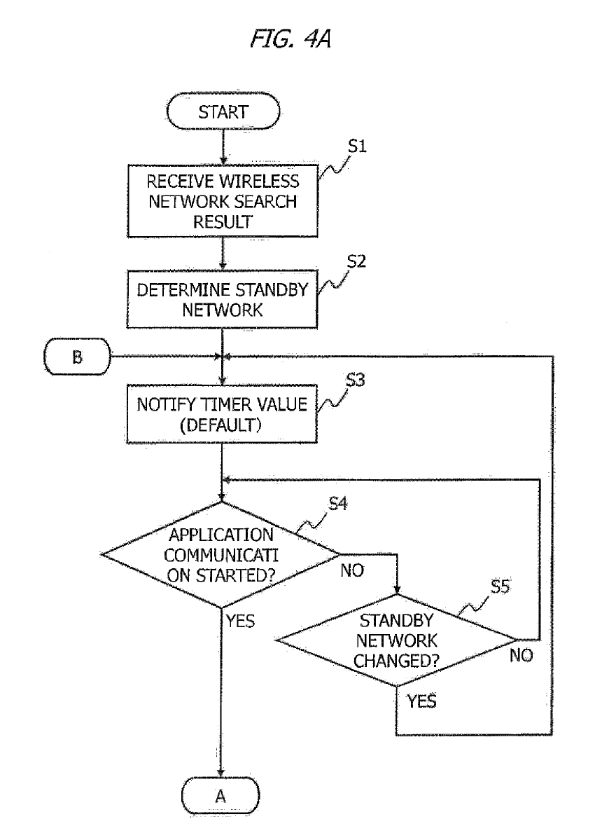

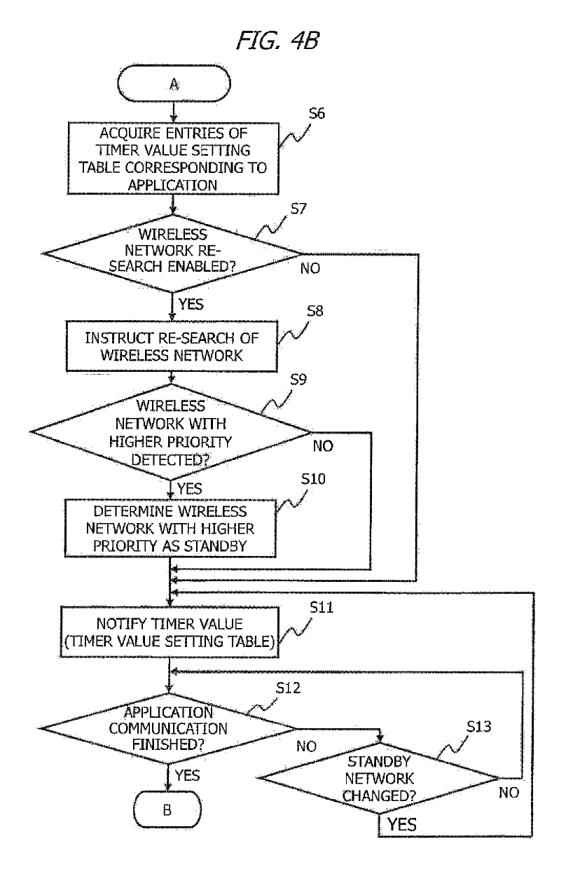

FIGS. 4A and 4B are an example of a flow chart of a process by the system selection unit 11. The flow chart illustrated in FIGS. 4A and 4B is started by activation of the wireless communication apparatus 1, for example. When the wireless communication apparatus 1 is activated, the 3G RF unit 108, the WiMAX RF unit 109, and the Wi-Fi RF unit 110 execute initialization processes and start searching each assigned wireless network. Hereinafter, the functional blocks will be mainly described in the description of the flow chart. Corresponding hardware of the system selection unit 11, the 3G processing unit 18, the WiMAX processing unit 17, and the Wi-Fi processing unit 16 is the processor 101, the 3G RF unit 108, the WiMAX RF unit 109, and the Wi-Fi RF unit 110, respectively.

In S1, the system selection unit 11 receives a search result of each assigned wireless network from each wireless processing unit. The process proceeds to S2.

In S2, the system selection unit 11 determines the standby network from the detected wireless networks. A wireless network with the highest priority among the detected wireless networks is determined as the standby network. The process proceeds to S3.

In S3, the system selection unit 11 acquires, through the information management unit 12, the default value of the timer for search according to the standby network in the timer value setting table and notifies the wireless processing units other than the standby of the default value. When the notification of the default timer value is received, each wireless processing unit other than the standby instructs the timer unit 14 to activate the timer for search. The system selection unit 11 notifies the wireless processing unit of the standby network of the fact that the network is selected as the standby network.

If, for example, the standby network is changed as a result of a re-search of the wireless network upon the expiration of the timer in each wireless process when communication by an application is not started (S4: No, S5: Yes), the process returns to S3. In S3 of this case, the system selection unit 11 acquires the default value of the timer for search according to the new standby network and notifies the wireless processing units other than the standby of the acquired timer value. The system selection unit 11 notifies the wireless processing unit of the newly selected standby network of the fact that the network is selected as the standby network.

If there is no communication by an application and no change in the standby network (S4: No, S5: No), the system selection unit 11 enters a waiting state until communication by an application is started or until the standby network is changed.

If communication by an application is started (S4: Yes), the process proceeds to S6 (FIG. 4B).

In S6, the system selection unit 11 acquires, from the information management unit 12, the entries of the timer value setting table corresponding to the activated application. In this case, the system selection unit 11 specifies the application from information of a destination domain, a port number, and the like, for example. Alternatively, the wireless communication apparatus 1 may include a dedicated API (Application Program Interface) for specifying the application.

If the re-search at the activation of the application is set to “enable” in the acquired entry (S7: Yes), the process proceeds to S8. If the re-search at the activation of the application is set to “disable” in the acquired entry (S7: No), the process proceeds to S11.

In S8, the system selection unit 11 instructs each wireless processing unit other than the standby to re-search each assigned wireless network. If a wireless network with a higher priority than the current standby network is detected (S9: Yes), the process proceeds to S10. In S10, the system selection unit 11 determines the wireless network with the higher detected priority as the standby network. The system selection unit 11 notifies the wireless processing unit of the newly selected standby network of the fact that the network is selected as the standby network. The process proceeds to S11.

In S11, the system selection unit 11 notifies each wireless processing unit other than the standby of the timer value corresponding to the application for communication and corresponding to the wireless network selected as the standby network. As a result, the wireless processing units other than the standby start the timers for search based on the timer values notified from the system selection unit 11.

Before the communication by the application ends (S12: No), if the standby network is changed as a result of the expiration of the timer and the re-search by each wireless processing unit (S13: Yes), the process returns to S11. In this case, the system selection unit 11 notifies the wireless processing units other than the standby of the timer values corresponding to the newly selected standby network in S11.

If the standby network is not changed (S13: No), the system selection unit 11 enters the waiting state until the communication by the application is finished or until the standby network is changed.

If a notification of the end of the communication is received from the application (S12: Yes), the process proceeds to S3, and the state before the start of the communication by the application is restored.

The flow chart illustrated in FIGS. 4A and 4B ends along with the termination of the activation of the wireless communication apparatus 1 due to power supply disconnection or the like, for example.

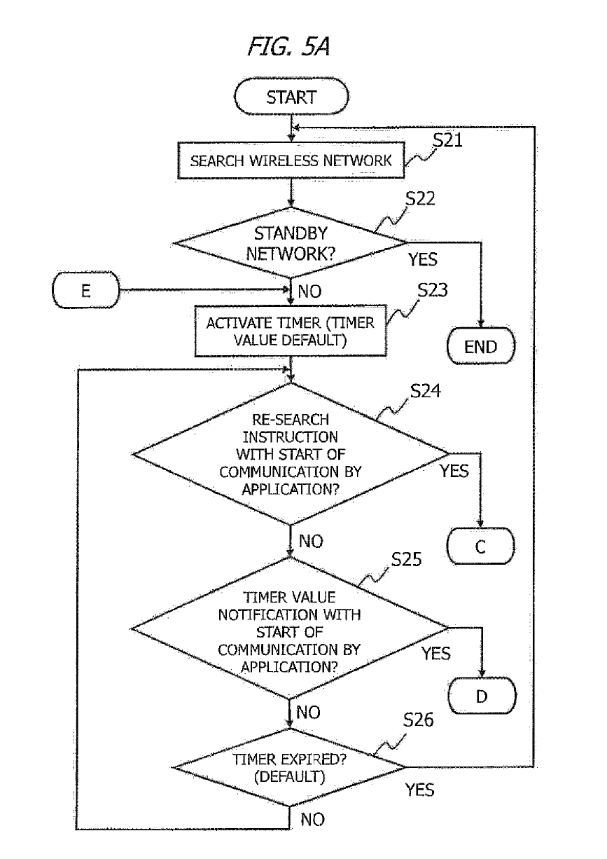

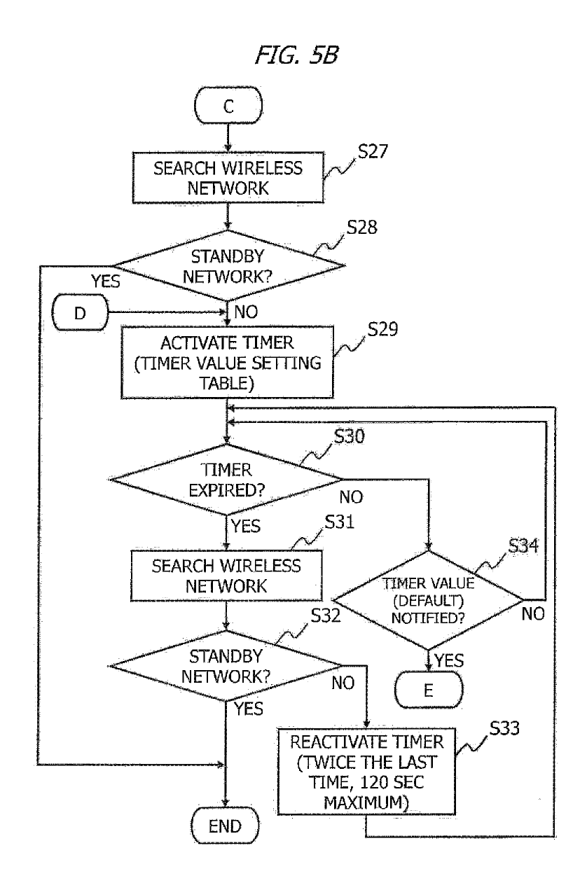

FIGS. 5A and 5B are an example of a flow chart of a process by the 3G processing unit 18, the WiMAX processing unit 17, and the Wi-Fi processing unit 16 of the wireless communication apparatus 1. The flow chart illustrated in FIGS. 5A and 5B is started by activation of the wireless communication apparatus 1.

In S21, when the wireless communication apparatus 1 is activated, the wireless processing unit searches the assigned wireless network. The wireless processing unit notifies the system selection unit 11 of a search result of the assigned wireless network. If the system selection unit 11 selects the assigned wireless network as the standby network (S22: Yes), the flow chart illustrated in FIG. 5A ends, and the wireless processing unit executes a standby process. If the assigned wireless network is not selected as the standby network (S22: No), the process proceeds to S23. If, for example, the wireless network assigned to the wireless processing unit is selected as the standby network, the wireless processing unit receives a notification from the system selection unit 11 indicating that the network is selected as the standby network. If the wireless network assigned to the wireless processing unit is not selected as the standby network, the timer value is notified from the system selection unit 11, for example.

In S23, the wireless processing unit instructs the timer unit 14 to activate the timer at the timer value notified from the system selection unit 11. The timer value in this case is the default value. If an instruction for re-searching the assigned wireless network associated with the start of the communication by the application is received from the system selection unit 11 (S24: Yes), the process proceeds to S27. If a notification of the timer value associated with the start of the communication by the application is received from the system selection unit 11 (S24: No, S25: Yes), the process proceeds to S29. If the timer expires without the generation of communication by the application (S26: Yes), the process proceeds to S21, and an assigned wireless network is searched. If communication by the application has not started (S24: No, S25: No) and the timer has not expired (S26: No), the system selection unit 11 enters the waiting state.

In S27, in response to an instruction from the system selection unit 11 associated with the start of communication by the application, the wireless processing unit searches the assigned wireless network. The search result of the assigned wireless network is transmitted to the system selection unit 11, and the system selection unit 11 selects a standby network. If the assigned wireless network is selected as the standby network (S28: Yes), the flow chart illustrated in FIG. 5B ends, and the wireless processing unit executes the standby process. If the assigned wireless network is not selected as the standby network (S28: No), the process proceeds to S29.

In S29, the wireless processing unit instructs the timer unit 14 to activate the timer at the timer value notified from the system selection unit 11. The timer value in this case is a timer value corresponding to the application and the standby network stored in the timer value setting table.

If the timer expires (S30: Yes), the process proceeds to S31. In S31, the wireless processing unit searches the assigned wireless network.

If the system selection unit 11 selects the assigned wireless network as the standby network (S32: Yes), the flow chart illustrated in FIG. 5B ends, and the wireless processing unit executes a standby process. If the assigned wireless network is not selected as the standby network (S32: No), the process proceeds to S33, and the wireless processing unit doubles the timer value and instructs the timer unit 14 to activate the timer at the timer value.

If the default timer value is notified from the system selection unit 11 before the expiration of the timer (S30: No, S34: Yes), the process proceeds to S23. In this case, the default timer value is notified in association with the end of the communication by the application, and after this, a process is executed in a state without the generation of communication by the application. More specifically, if communication by the application is not generated before the expiration of the timer with the default value (S23: No, S25: No), the wireless processing unit searches the assigned wireless network (S21) when the timer with the default value expires (S26: Yes).

If the default timer value is not notified from the system selection unit 11 before the expiration of the timer (S30: No, S34: No), the processes of S30 and S34 are repeated until the timer expires or until the default timer value is notified from the system selection unit 11.

If the standby network is changed from the assigned wireless network to another wireless network when communication by the application is not generated, the process by the wireless processing unit is started from S23. If communication by the application is generated, the process by the wireless processing unit is started from S29.

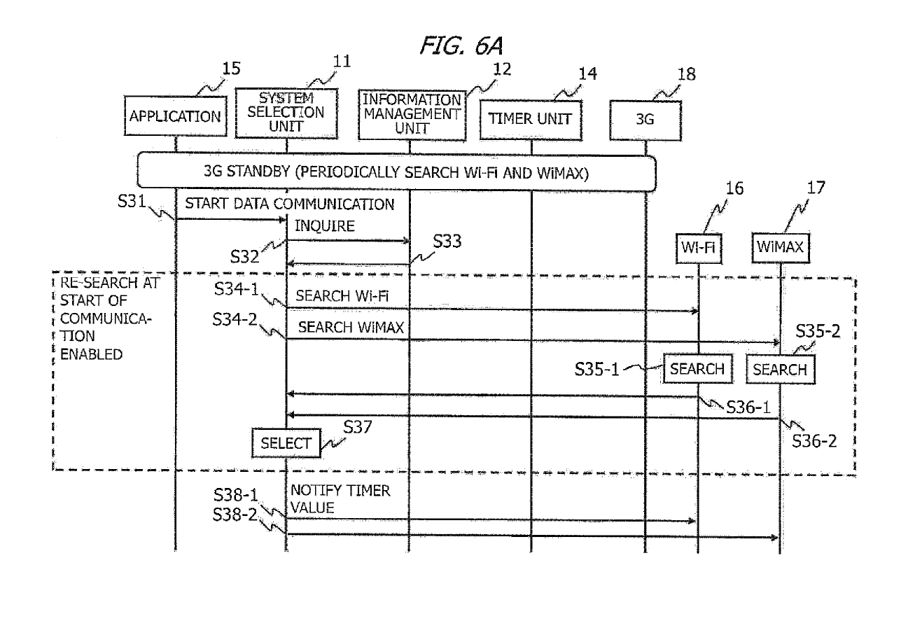

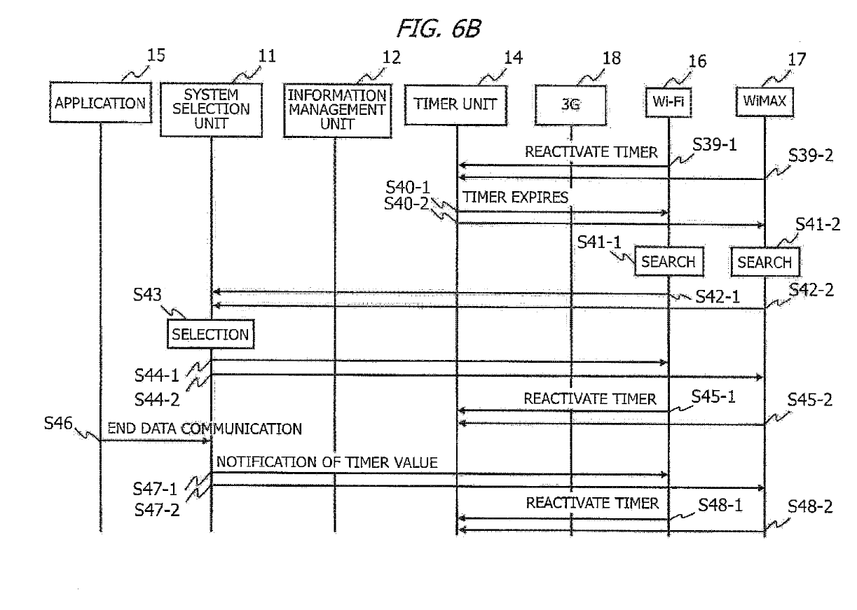

FIGS. 6A and 6B are diagrams illustrating an example of a sequence of a process between the functional blocks of the wireless communication apparatus 1.

FIGS. 6A and 6B illustrate operation of the functional blocks of the wireless communication apparatus 1 when communication by an application is started while 3G is selected as the standby network.

In S31, the application 15 notifies the system selection unit 11 of the start of the communication. In S32, the system selection unit 11 receives the notification of the start of the communication by the application (FIG. 4A, S4: Yes) and inquires the information management unit 12 for the entries in the timer value setting table of the application (S4B, S6). The type of the application is determined by, for example, a destination domain or a port number. Alternatively, an API dedicated for determining the type of the application may be used.

In S33, in response to the inquire from the system selection unit 11, the information management unit 12 reads the entries of the application from the timer value setting table stored in the storage unit 13 and notifies the system selection unit 11 of the entries.

In the notified entries, if the search of the wireless network at the start of communication is set to “enable” (FIG. 4B, S7: Yes), the following processes of S34 to S37 are executed.

In S34-1 and S34-2, the system selection unit 11 instructs the Wi-Fi processing unit 16 and the WiMAX processing unit 17 to search the wireless networks (FIG. 4B, S8). The Wi-Fi processing unit 16 and the WiMAX processing unit 17 are wireless processing units in charge of the wireless networks that are not the standby network in FIG. 6A. In S35-1 and S35-2, in response to the instruction from the system selection unit 11, the Wi-Fi processing unit 16 and the WiMAX processing unit 17 search the assigned wireless networks, respectively (FIG. 5A, S24: Yes, FIG. 5B, S27). In S36-1 and S36-2, the Wi-Fi processing unit 16 and the WiMAX processing unit 17 notify the system selection unit 11 of the search results of the wireless networks, respectively.

In S37, in response to the search results from the Wi-Fi processing unit 16 and the WiMAX processing unit 17, the system selection unit 11 selects a standby network. In the example illustrated in FIG. 6A, it is assumed that Wi-Fi and WiMAX are not detected and that the standby network is still 3G (FIG. 4B, S9: No). The following process is a common process, regardless of enable/disable of the re-search at the start of communication.

In S38-1 and S38-2, the system selection unit 11 notifies the Wi-Fi processing unit 16 and the WiMAX processing unit 17 of the timer values for search corresponding to the application and the standby network (3G) (FIG. 4B, S11).

In S39-1 and S39-2, the Wi-Fi processing unit 16 and the WiMAX processing unit 17 instruct the timer unit 14 to reactivate the timer at the timer values notified from the system selection unit 11, respectively (FIG. 5B, S28: No, S29). As a result, the timer unit 14 activates the timer. In S40-1 and S40-2, since the communication by the application does not end, the timer unit 14 notifies the Wi-Fi processing unit 16 and the WiMAX processing unit 17 of the expiration of the timer (FIG. 5B, S30: Yes).

In S41-1 and S41-2, in response to the notification of the expiration of the timer, the Wi-Fi processing unit 16 and the WiMAX processing unit 17 search the Wi-Fi and WiMAX, respectively (FIG. 5B, S31). In S42-1 and S42-2, the Wi-Fi processing unit 16 and the WiMAX processing unit 17 notify the system selection unit 11 of the search results of the wireless networks.

In S43, in response to the search results from the Wi-Fi processing unit 16 and the WiMAX processing unit 17, the system selection unit 11 selects a standby network. In the example illustrated in FIG. 6B, it is assumed that Wi-Fi and WiMAX are not detected and that the standby network is still 3G (FIG. 4B, S13: No).

In S44-1, and S44-2, the system selection unit 11 notifies the Wi-Fi processing unit 16 and the WiMAX processing unit 17 of the result of the selection of the standby network. The notification of S44-1 and S44-2 may not be performed. In that case, each wireless processing unit recognizes that the assigned wireless network is not selected as the standby network from the fact that there is no notification of the selection as the standby network for a predetermined time.

In S45-1 and S45-2, the Wi-Fi processing unit 16 and the WiMAX processing unit 17 instruct the timer unit 14 to reactivate the timers (FIG. 5B, S32: No, S33). The timer values in this case are set to twice as much as the last timer values. In this way, the timer unit 14 activates the timers.

In S46, the communication by the application 15 ends, and the application 15 notifies the system selection unit 11 of the end of the communication (FIG. 4B, S12: Yes). In S47-1 and S47-2, in response to the notification of the end of the communication from the application 15, the system selection unit 11 notifies the Wi-Fi processing unit 16 and the WiMAX processing unit 17 of the default timer value (FIG. 4A, S3).

In S48-1 and S48-2, in response to the notification from the system selection unit 11 (FIG. 5B, S34: Yes), the Wi-Fi processing unit 16 and the WiMAX processing unit 17 instruct the timer unit 14 to reactivate the timers (FIG. 5A, S23). The timer value in this case is the default value.

In the first embodiment, the timer value for search when the communication is performed by the application is a value set according to the communication characteristics of the application and according to the use priority of the standby network. Therefore, the search is performed at appropriate timing for the application. In the first embodiment, enable/disable of the execution of re-search at the start of the communication is set according to the characteristics of the communication by the application. As a result, the re-search is performed according to the characteristics of the communication by the application. Therefore, for example, a faster wireless network can be used for the communication, or the power consumption can be reduced by reducing the number of executions of the search.

### Specific Example 1

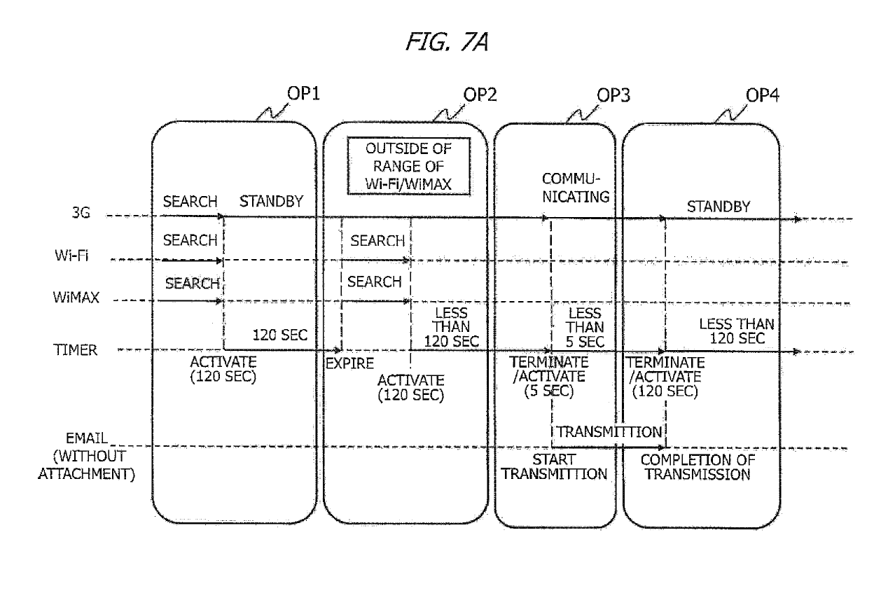

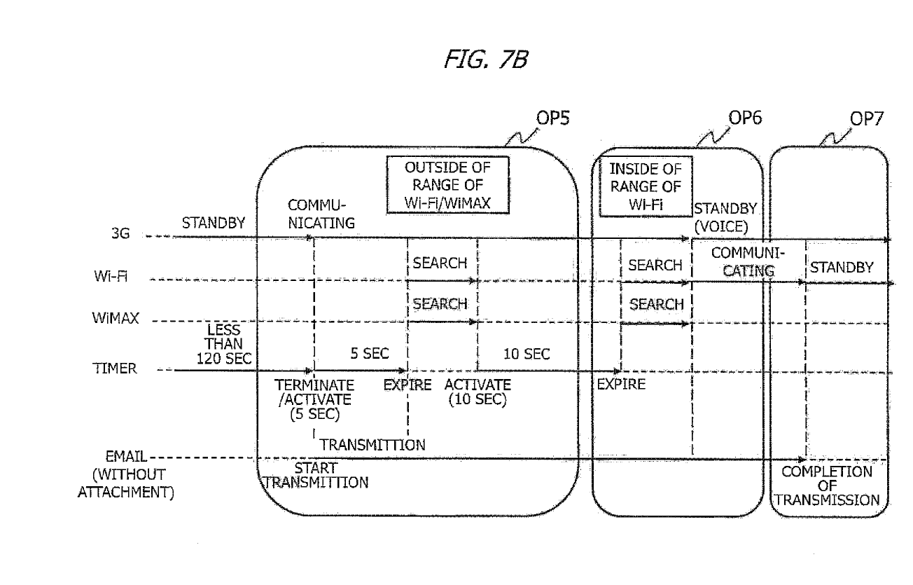

FIGS. 7A and 7B are diagrams illustrating a specific example 1 of state transitions of the wireless communication apparatus 1. FIGS. 7A and 7B illustrate state transitions of the 3G processing unit 18, the Wi-Fi processing unit 16, the WiMAX processing unit 17, the timer unit 14, and the application.

The specific example 1 is an example in which the standby network is 3G, and communication is performed by the application of email without attached file. In the following specific example, the timer value setting table in the example illustrated in FIG. 3 is used.

In OP1, for example, each wireless processing unit searches each wireless network when the wireless communication apparatus 1 is activated (FIG. 5A, S21). In OP1, 3G is selected as the standby network, and the 3G processing unit 18 enters the standby state (FIG. 5A, S22: Yes). The Wi-Fi processing unit 16 and the WiMAX processing unit 17 activate the timers (FIG. 5A, S22: No, S23). The timer value is the default value of 120 seconds (see FIG. 3).

In OP2, the timer (120 seconds) expires, and the Wi-Fi processing unit 16 and the WiMAX processing unit 17 search, for Wi-Fi and WiMAX, whether there is a network with a higher priority than 3G that is the standby network (FIG. 5A, S26: Yes, S21). In OP2, the wireless communication apparatus 1 is positioned outside of the range of Wi-Fi and WiMAX, and Wi-Fi and WiMAX are not detected. Therefore, the standby network is not changed, and the standby network is still 3G. The Wi-Fi processing unit 16 and the WiMAX processing unit 17 reactivate the timers at the default value of 120 seconds (FIG. 5A, S22: No, S23).

In OP3, the communication is started by the application of email without attached file before the expiration of the timer (120 seconds). In the timer value setting table, the re-search of the wireless network at the start of communication by the application of email without attached file is set to “disable” (see FIG. 3), and the wireless networks are not searched. Therefore, the communication is performed using 3G that is the standby network. In the timer value setting table, the timer value is 5 seconds when the standby network of the application of email without attached file is 3G. Therefore, the Wi-Fi processing unit 16 and the WiMAX processing unit 17 reactivate the timers at the timer value of 5 seconds (FIG. 5A, S25: Yes, FIG. 5B, S29).

In OP4, the communication by the application of email without attached file ends before the expiration of the timer (5 seconds). In this case, the standby network is still 3G. The Wi-Fi processing unit 16 and the WiMAX processing unit 17 reactivate the timers at the default value of 120 seconds (FIG. 5B, S30: No, S34: Yes, FIG. 5A, S23).

In OP5, the communication is started by the application of email without attached file before the expiration of the timer (120 seconds). In this case, the wireless networks are not searched, and the communication is performed using 3G that is the standby network. The Wi-Fi processing unit 16 and the WiMAX processing unit 17 reactivate the timers at the timer value of 5 seconds (FIG. 5A, S25: Yes, FIG. 5B, S29). The communication continues even after the expiration of the timer (5 seconds), and the Wi-Fi processing unit 16 and the WiMAX processing unit 17 search the wireless networks (FIG. 5B, S30: Yes, S31). In OP5, the wireless communication apparatus 1 is positioned outside of the range of Wi-Fi and WiMAX, and Wi-Fi and WiMAX are not detected. Therefore, the Wi-Fi processing unit 16 and the WiMAX processing unit 17 reactivate the timers at the timer value of 10 seconds which is twice as long (FIG. 5B, S32: No, S33).

In OP6, the communication continues even after the expiration of the timer (10 seconds), and the Wi-Fi processing unit 16 and the WiMAX processing unit 17 search the wireless networks (FIG. 5B, S30: Yes, S31). In OP6, the wireless communication apparatus 1 is positioned in the range of Wi-Fi as a result of a movement, for example. Therefore, Wi-Fi is detected. Since the priority of the Wi-Fi is higher than 3G, the standby network is changed to Wi-Fi, and communication is performed using Wi-Fi (FIG. 5B, S32: Yes). Since the priority of Wi-Fi is the highest, wireless networks are not searched while Wi-Fi is captured, and the timers are not activated. 3G is also used for a voice call, and 3G enters the standby state for a voice call.

In OP7, the communication by the application of email without attached file ends, and after that, Wi-Fi continues to be the standby network.

In the specific example 1, the communication by the application does not end in OP5 even if the timer value (5 seconds) has passed. The amount of communication by the email without attached file is small, and the communication is sporadic. Therefore, the timer value is set to a value with which the communication is sufficiently completed. If the communication is not completed when the timer expires (5 seconds) as in OP5, the radio wave environment may be poor, and Wi-Fi and WiMAX are re-searched. As a result, if Wi-Fi or WiMAX is detected, the standby network is changed to the detected wireless network, and the communication continues without disconnection.

However, Wi-Fi and WiMAX are not detected by the re-search of Wi-Fi and WiMAX in OP5, and 3G is used to continue the communication. At this point, the timer value at the reactivation of the timer is set to 10 seconds which is twice as long. In this case, if the communication is not completed based on the timer value (5 seconds) notified by the system selection unit 11, it is predicted that network is not detected as a result of the execution of the search due to a poor radio wave environment or the like. Therefore, if the communication is not completed based on the timer value (5 seconds) notified by the system selection unit 11, the timer value is extended to reduce the frequency of the re-search, and the power consumption of the wireless communication apparatus 1 caused by the search is reduced.

### Specific Example 2

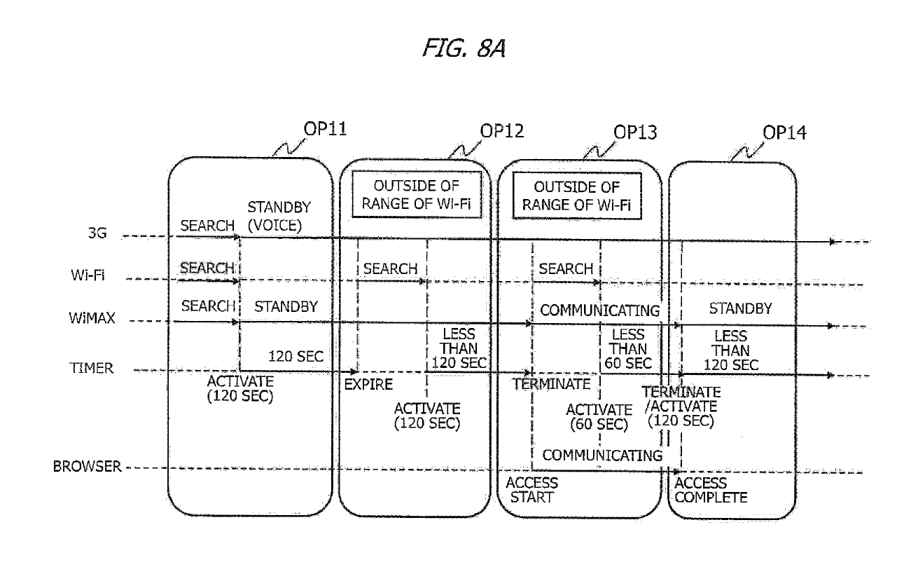

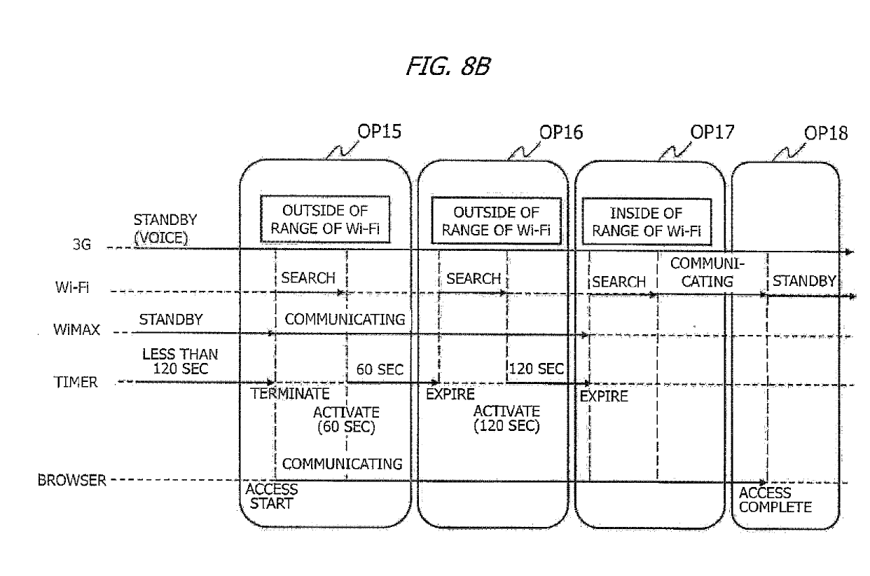

FIGS. 8A and 8B are diagrams illustrating a specific example 2 of the state transitions of the wireless communication apparatus 1. The specific example 2 is an example in which the standby network is WiMAX, and communication is performed by the browser.

In OP11, each wireless processing unit searches each wireless network when the wireless communication apparatus 1 is activated, for example (FIG. 5A, S21). In OP11, WiMAX is selected as the standby network, and the WiMAX processing unit 17 enters the standby state (FIG. 5A, S22: Yes). The Wi-Fi processing unit 16 activates the timer (FIG. 5A, S22: No, S23). The timer value is the default value of 120 seconds (see FIG. 3). 3G is in the standby state for a voice call, and 3G is captured. Therefore, the 3G processing unit 18 does not instruct the activation of the timer and does not perform the search.

In OP12, the timer (120 seconds) expires, and the Wi-Fi processing unit 16 searches whether there is a network with a higher priority than WiMAX that is the standby network (FIG. 5A, S26: Yes, S21). In the example illustrated in FIG. 8A, 3G is in the standby state for a voice call, and in this case, the search is not performed. In OP12, the wireless communication apparatus 1 is positioned outside of the range of Wi-Fi, and Wi-Fi as a wireless network with a higher priority than WiMAX is not detected. Therefore, the standby network is not changed, and the standby network is still WiMAX. The Wi-Fi processing unit 16 reactivates the timer at the default value of 120 seconds (FIG. 5A, S22: No, S23).

In OP13, the communication by the browser is started before the expiration of the timer (120 seconds). In the timer value setting table, since the re-search of the wireless network at the start of communication by the browser is set to “enable”, the wireless network is searched. In the example illustrated in FIG. 8A, the Wi-Fi processing unit 16 searches Wi-Fi (FIG. 5A, S24: Yes, FIG. 5B, S27). However, the wireless communication apparatus 1 is positioned outside of the range of Wi-Fi in OP13, and Wi-Fi is not detected. Therefore, the standby network is not changed, and the communication is performed using WiMAX that is the standby network. In the timer value setting table, the timer value is 60 seconds when the standby network of the browser is WiMAX. Therefore, the Wi-Fi processing unit 16 reactivates the timer at the timer value of 60 seconds (FIG. 5B, S28: No, S29).

In OP14, the communication by the browser ends before the expiration of the timer (120 seconds). The standby network continues to be WiMAX, and the Wi-Fi processing unit 16 reactivates the timer at the default value of 120 seconds (FIG. 5B, S30: No, S34: Yes, FIG. 5A, S23).

In OP15, the communication is started by the browser before the expiration of the timer (120 seconds). In this case, the Wi-Fi processing unit 16 searches the wireless network (FIG. 5A, S24: Yes, FIG. 5B, S27). In OP15, the wireless communication apparatus 1 is positioned outside of the range of Wi-Fi, and Wi-Fi is not detected. Therefore, the standby network is not changed, and the communication is performed using WiMAX that is the standby network. The Wi-Fi processing unit 16 reactivates the timer at the timer value of 60 seconds (FIG. 5B, S28: No, S29).

In OP16, the timer (60 seconds) expires during the communication by the browser, and the Wi-Fi processing unit 16 searches the wireless network (FIG. 5B, S30: Yes, S31). In OP16, the wireless communication apparatus 1 is positioned outside of the range of Wi-Fi, and Wi-Fi is not detected. Therefore, the standby network is not changed. In this case, the Wi-Fi processing unit 16 reactivates the timer at 120 seconds which is twice as long as the last timer value (FIG. 5B, S32: No, S33).

In OP17, the communication by the browser continues even after the expiration of the timer (120 seconds), and the Wi-Fi processing unit 16 searches the wireless network (FIG. 5B, S30: Yes, S31). In OP17, the wireless communication apparatus 1 is positioned in the range of Wi-Fi as a result of a movement, for example. Therefore, Wi-Fi is detected. Since the priority of Wi-Fi is higher than WiMAX, the standby network is changed to Wi-Fi, and the communication is performed using Wi-Fi. The Wi-Fi processing unit 16 executes a process related to the communication (FIG. 5B, S32: Yes). Since the priority of Wi-Fi is the highest, a wireless network is not searched while Wi-Fi is the standby network, and the timer is not activated.

In OP18, the communication by the browser ends, and after that, Wi-Fi continues to be the standby network.

In the specific example 2, the browser performs the communication. Sporadic access tends to continue for a long time in the communication by the browser, and the timer for re-search is set to 60 seconds which is relatively long. As a result, the number of executions of the search can be reduced, and the power consumption of the wireless communication apparatus can be reduced. Since the search is performed at the start of the communication by the browser, a faster wireless network can be used to perform the communication.

### Effects of First Embodiment

In the first embodiment, the wireless communication apparatus 1 includes the timer value setting table. The timer value for search is set in the timer value setting table according to the characteristics and tendency of communication by the application and according to the wireless network selected as the standby network. When the application performs the communication, the timer value set in the timer value setting table is used. The enable/disable of re-search at the start of the communication is also set in the timer value setting table according to the characteristics and tendency of the communication by the application. As a result, the search of the wireless network is executed at appropriate timing according to the characteristics and tendency of the communication by the application and according to the use priority of the standby network. Therefore, the wireless communication apparatus 1 can use a faster wireless access network for the communication and can reduce the power consumption.

According to the disclosed wireless communication apparatus and wireless communication method, a search of a wireless access network among a plurality of available wireless access networks can be carried out at appropriate timing according to an application and according to a wireless communication access network selected as a standby.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more the embodiments of the present invention have been described in detail, it should be understood that the various changes, substitutions, and alterations could be made hereto without departing from the spirit and scope of the invention.

What is claimed is:

1. A wireless communication apparatus that can be connected to a plurality of wireless access networks, the wireless communication apparatus comprising:
a storage unit that stores timer values for a search of each of the plurality of wireless access networks, wherein each of the timer values is set according to communication characteristics of an application and according to a use priority of a wireless access network, and each of the timer values is associated with the application and the wireless access network;
a timer unit that activates, when communication by an application is started, a timer at a timer value that is stored in the storage unit and that is associated with the application and associated with a wireless access network selected as a standby; and
a selection unit that newly selects, when a wireless access network with a higher use priority than the wireless access network selected as the standby is detected by a search of the wireless access network on expiration of the timer during the communication, the wireless access network with the higher use priority as a standby network.

2. The wireless communication apparatus according to claim 1, wherein
the storage unit stores enable/disable of execution of a search of a wireless access network at a start of communication according to the application, and
after activation of the application, the selection unit instructs a re-search of the plurality of wireless access networks according to the enable/disable of the execution of the search of the wireless access network at the start of the communication stored in the storage unit and corresponding to the application.

3. The wireless communication apparatus according to claim 1, wherein
when a wireless access network with a higher priority than the wireless access network selected as the standby is not detected by the search of the wireless access network executed on expiration of the timer during the communication, the timer unit activates the timer at a timer value that is a predetermined time length longer than the timer value associated with the application and associated with the wireless access network selected as the standby.

4. The wireless communication apparatus according to claim 1, wherein
the timer value for search stored in the storage unit is set shorter for an application with a larger amount of communication.

5. The wireless communication apparatus according to claim 1, wherein
the timer value for search stored in the storage unit is set longer for an application with a longer communication continuation time.

6. A wireless communication method executed by a wireless communication apparatus that can be connected to a plurality of wireless access networks, the wireless communication method comprising:
storing timer values for a search of each of the plurality of wireless access networks, wherein each of the timer values is set according to communication characteristics of an application and according to a use priority of a wireless access network, and each of the timer values is associated with the application and the wireless access network;
activating, when communication by an application is started, a timer at a timer value associated with the application and associated with a wireless access network selected as a standby; and
newly selecting, when a wireless access network with a higher use priority than the wireless access network selected as the standby is detected by a search of the wireless access network on expiration of the timer during the communication, the wireless access network with the higher use priority as a standby network.
